(19) United States
(12) Patent Application Publication
(10) Pub. No.: US 2016/0275067 A1
(43) Pub. Date: Sep. 22, 2016

(54) DOMAIN-BASED GENERATION OF COMMUNICATIONS MEDIA CONTENT LAYOUT

(71) Applicant: Microsoft Technology Licensing, LLC, Redmond, WA (US)

(72) Inventors: Tao Mei, Beijing (CN); Yong Rui, Sammamish, WA (US); Shipeng Li, Atherton, CA (US)

(21) Appl. No.: 14/664,365

(22) Filed: Mar. 20, 2015

(51) Int. Cl. G06F 17/24; G06T 11/60; G06F 17/21

(52) U.S. Cl. CPC G06F 17/248; G06F 17/212; G06T 11/60

(57) ABSTRACT

A layout generator generates a layout for communications media content based on an identified domain (e.g., topic). A communications media content analyzer identifies a domain associated with communications media content. A domain-based layout guide selector receives the identified domain from the communications media content analyzer and selects a domain-based layout guide based on the identified domain. The domain-based layout guide is selected from a set of domain-based layout guides stored in memory accessible by the one or more processors. The set of domain-based layout guides is associated with multiple domains. A communications media content layout generator receives the selected domain-based layout guide from the domain-based layout guide selector and generates a communications media content layout incorporating at least a subset of the communications media content. The communications media content layout complies with the selected domain-based layout guide.

### BACKGROUND

Visual-textual layout combines images with relevant text for communications media, such as magazine covers and pages, web pages, posters, and other communications media, both online and offline. However, existing manual and automated design and layout approaches continue to be labor intensive and/or produce poor layout results.

### SUMMARY

The described technology evaluates representative images and/or text to determine a domain associated with an intended communications media composition and employs domain-based constraints, including without limitation layout constraints, image composition and color schemes, typography, and/or text color themes, to automatically generate a domain-appropriate media content layout for the communications media composition.

A communications media content analyzer executes on one or more processors and identifies a domain associated with communications media content. A domain-based layout guide selector executes on the one or more processors, receives the identified domain from the communications media content analyzer, and selects a domain-based layout guide based on the identified domain. The domain-based layout guide is selected from a set of domain-based layout guides stored in memory accessible by the one or more processors. The set of domain-based layout guides is associated with multiple domains. A communications media content layout generator executes on the one or more processors, receives the selected domain-based layout guide from the domain-based layout guide selector, and generates a communications media content layout incorporating at least a subset of the communications media content. The communications media content layout complies with the selected domain-based layout guide.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example layout generation system for generating domain-based layout of communications media content.

FIG. 2 illustrates another example layout generation system for generating domain-based layout of communications media content.

FIG. 3 illustrates example domain-based spatial layout templates useful in generating domain-based layout of communications media content.

FIG. 4 illustrates a framework for an example layout generation system for generating domain-based layout of communications media content.

FIG. 5 illustrates an example process for domain-based alignment of an input image to a target layout.

FIG. 6 illustrates an example domain-based typography composition process for a domain-based layout of communications media content.

FIG. 7 illustrates an example domain-based color composition process for a domain-based layout of communications media content.

FIG. 8 illustrates an example system useful for generating a domain-based communications media content layout.

### DETAILED DESCRIPTIONS

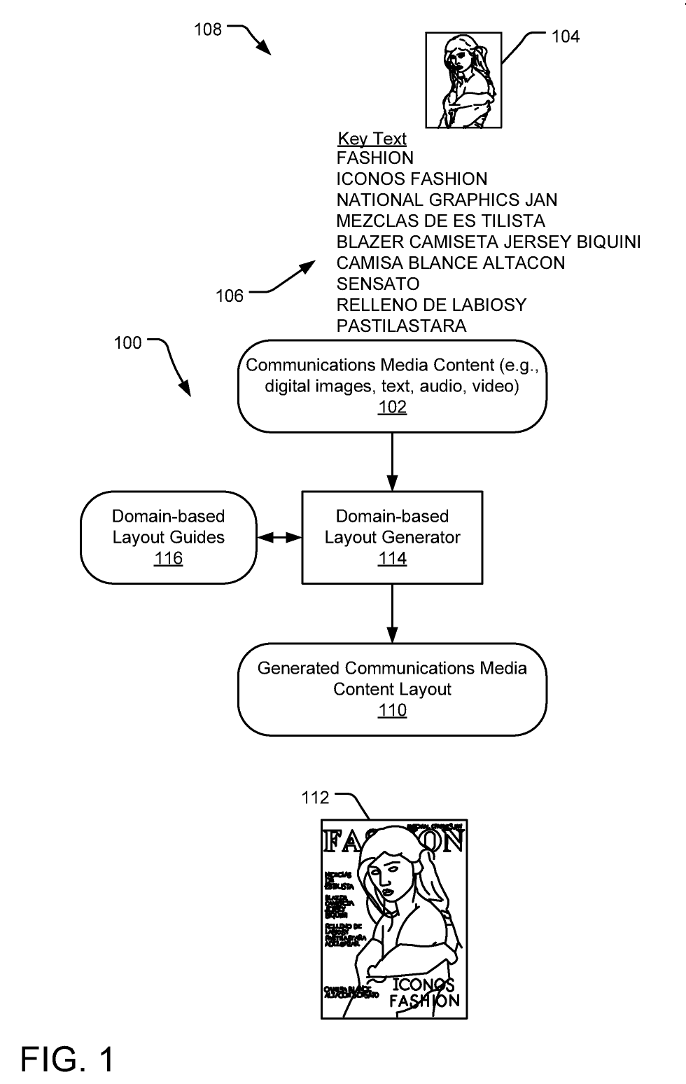

FIG. 1 illustrates an example layout generation system 100 for generating domain-based layout of communications media content 102. An example of communications media content 102 is provided as content 108. As shown, the communications media content 108 includes an image 104 and key text 106, although other content may be employed, including without limitation audio and video content, embedded files, placeholders for served graphical controls, etc. The communications media content 102 may be in the form of markup language data, associated image data, text data, metadata, other media content resources, and potentially specific topic identifiers. The communications media content 102 is input to the layout generation system 100 for composition into a variety of communications media types, including without limitation magazines, brochures, newspapers, and newsletter covers and pages; posters; slides for presentations; online self-published rich media; graphic novels; and other types of communications media. In FIG. 1, a generated communications media content layout 110 is output by the layout generation system 100, as shown by the example composition 112.

The layout generation system 100 can provide user-friendly automated layout of communications media, reducing the layout effort on a user-publisher and improving the reading experience of the user-reader by providing a domain-appropriate and enhancing layout. Accordingly, an unsophisticated user-publisher can input communications media content 102 into the layout generation system 100, which analyzes the content and produces a communications media content layout that bridges a gap between domain-specific design knowledge and computational content features to more effectively communicate to an intended domain audience. Accordingly, the layout generation system 100 and other related implementations can improve text and image display to improve reader efficiency and reduce reader fatigue. The layout generation system 100 and other related implementations can also enhance the communication of media content so as to better influence a reader's emotional response to the communications media content.

As shown in FIG. 1, a domain-based layout generator 114, implemented as a processor-based system executing processor-executable instructions retrieved from one or more tangible computer-readable storage media, receives the communications media content 102 as input, evaluates the content 102 to determine a related domain (e.g., a topic to which the content 102 is directed), selects one or more domain-based layout guides 116, and composes the content 102 into the generated communications media content layout 110. In another implementation, the domain-based layout generator 114 may present a user-publisher with a variety of domain-based layout options from which to select for publication.

It should be understood that the layout generation system 100 may be implemented as a workstation, a laptop computer, a tablet computing device, a mobile computing device, a service system of one or more computing systems, and other physical computing systems. Furthermore, tangible computer-readable storage media are embodied by one or more physical articles of manufacture and not by one or more carrier waves.

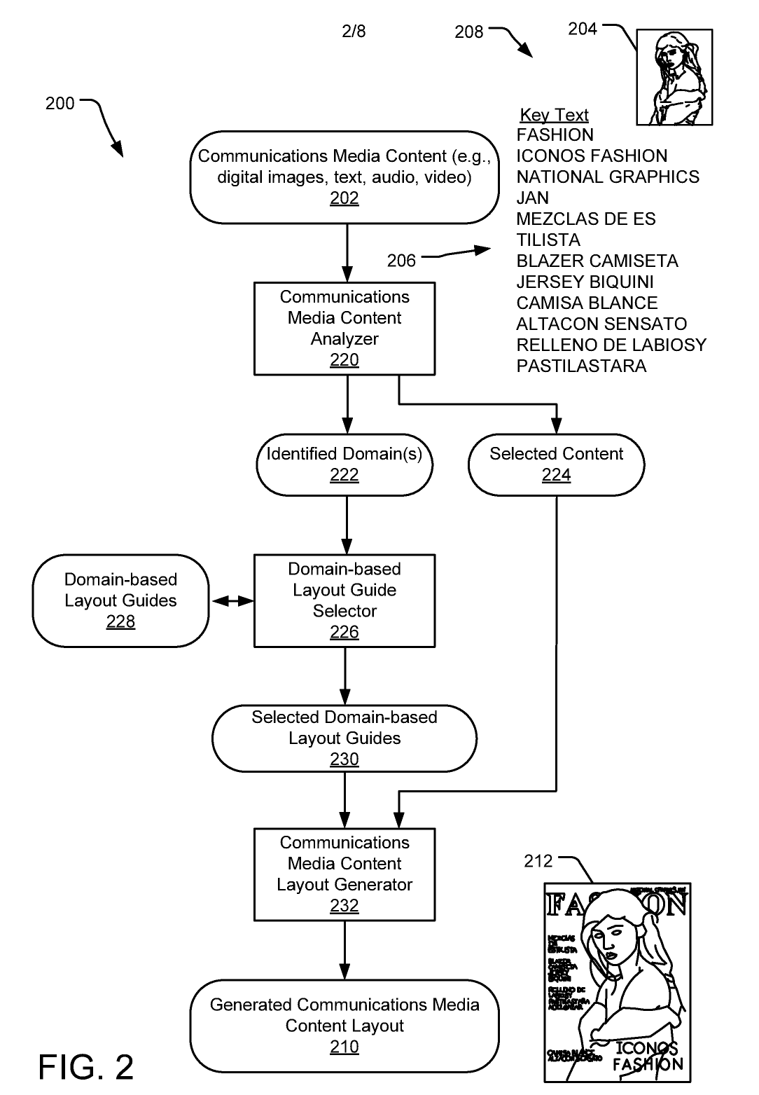

FIG. 2 illustrates another example layout generation system 200 for generating domain-based layout of communications media content 202. An example of communications media content 202 is provided as content 208. As shown, the communications media content 208 includes an image 204 and key text 206, although other content may be employed, including without limitation audio and video content, embedded files, placeholders for served graphical controls, etc. The communications media content 202 is input to the layout generation system 200 for composition into a variety of communications media types, including without limitation magazines, brochures, newspapers, and newsletter covers and pages; posters; slides for presentations; online self-published rich media; graphic novels; and other types of communications media. In FIG. 2, generated communications media content layout 210 is output by the layout generation system 200, as shown by the example composition 212. The communications media content analyzer 220 uses this input to output one or more identified domains 222 (e.g., “fashion,” “food & drink,” “computing,” “travel,” a topic designator represented by an index or GUID, etc.).

As shown in FIG. 2, the communications media content 202 is input to a communications media content analyzer 220. The communications media content 202 may be in the form of markup language data, a link to a web page with associated content, associated image data, text data, metadata, other media content resources, and potentially specific domain identifiers (e.g., topic identifiers). The communications media content analyzer 220 analyzes the communications media content 202 and identifies the one or more identified domains 222. In addition, the communications media content analyzer 220 may also select elements of selected content 224 from the communications media content 202, such as one or more dominant images, key text, and other relevant content elements, including without limitation, video and audio files, etc.

In one implementation, the communications media content analyzer 220 performs dominant image extraction, key text extraction, and/or domain identification. A variety of dominant image extraction techniques, both simple and sophisticated, may be employed. In one implementation, the first image encountered in the analysis of the communications media content 202 may be selected as the dominant image. This approach is more likely to be successful when the communications media content 202 is already organized in some sense (e.g., already composed into a webpage or article), as composition by a previous author tends to place a dominant image at the beginning of input communication media (e.g., at the beginning of the webpage or article). Nevertheless, other criteria may be used to identify a dominant image, including without limitation, by employing feature recognition to identify images having relevant features (e.g., faces, scenery, flowers, automobiles, keyboards, computers, etc.). Relevancy of an image and/or its features can be based on one or more supplied and/or identified domains for the generated communications media content layout 210. For example, if an analysis of the communications media content 202 identifies the domain as “fashion,” the dominant image may be selected based on facial feature recognition, the size and placement of the face in the image relative to other features, etc. Other dominant image extraction techniques may be employed including selecting a dominant image based on image sharpness, brightness, spatial frequency, etc. The dominant image and/or other images may be used as the background image or part of the background image in the generated composition.

Key text can express information concisely and accurately, while wordy sentences tend to dilute the focus or topic of textual content. Accordingly, key text extraction can be employed to extract key phrases and terms and to determine their importance to a potential domain (e.g., to determine their utility value). In one implementation, the communications media content analyzer 220 extracts key text using a modified TextRank approach, although other techniques may be employed.

Phases of an example key text extraction process include word extraction, word ranking, and key phrase reconstruction. The communications media content analyzer 220 tokenizes the textual elements of the communications media content 202, such as by separating the textual elements into words, phrases, symbols or other meaningful elements called tokens. The communications media content analyzer 220 then performs part-of-speech annotation to assign a code to each token that indicates that token's grammatical nature (e.g., singular common noun, comparative adjective, past participle, etc.). Based on the tokenized and annotated text, the communications media content analyzer 220 performs syntactic filter, such as by constructing a graph in memory by selecting nouns and adjectives as vertices in the graph and utilizing the co-occurrence relationship controlled by the distances between words to generate the edges between vertices. Two vertices are connected if they co-occur within a window of N_{w} (e.g., N_{w}=2) words. The extracted text units and their relationship can be represented as an undirected graph G=(V,E) with the set of vertices V and the set of edges E.

Each extracted word in the graph is ranked relative to the other extracted words. Various semantic portions of the communications media content 202 may be weighted higher than other semantic portions. For example, in one implementation, words in a title may be more highly weighted than those in a footer. The utility values of the vertices in the graph are decided by evaluating global information recursively from the entire graph by Equation (1) until convergence:

$$U ( {V}_{i} ) = ( 1 - d ) + d \cdot {\sum }_{{V}_{j} ∈ S ( {V}_{i} )} \frac{{w}_{i}}{{\sum }_{{V}_{k} ∈ S ( {V}_{j} )} {w}_{k}} U ( {V}_{j} ) \qquad ( 1 )$$

where d is a damping factor that integrates the probability of jumping from a given vertex to another in the graph. In one implementation, d is set to 0.85, although other values may be used. Further, in one implementation, the top third of vertices are retained for post-processing, although other portions of the graph may be employed for the same purpose.

In the key phrase reconstruction phase, the communications media content analyzer 220 generates multi-word key phrases from the extracted, ranked, and retained words output from the word ranking phase.

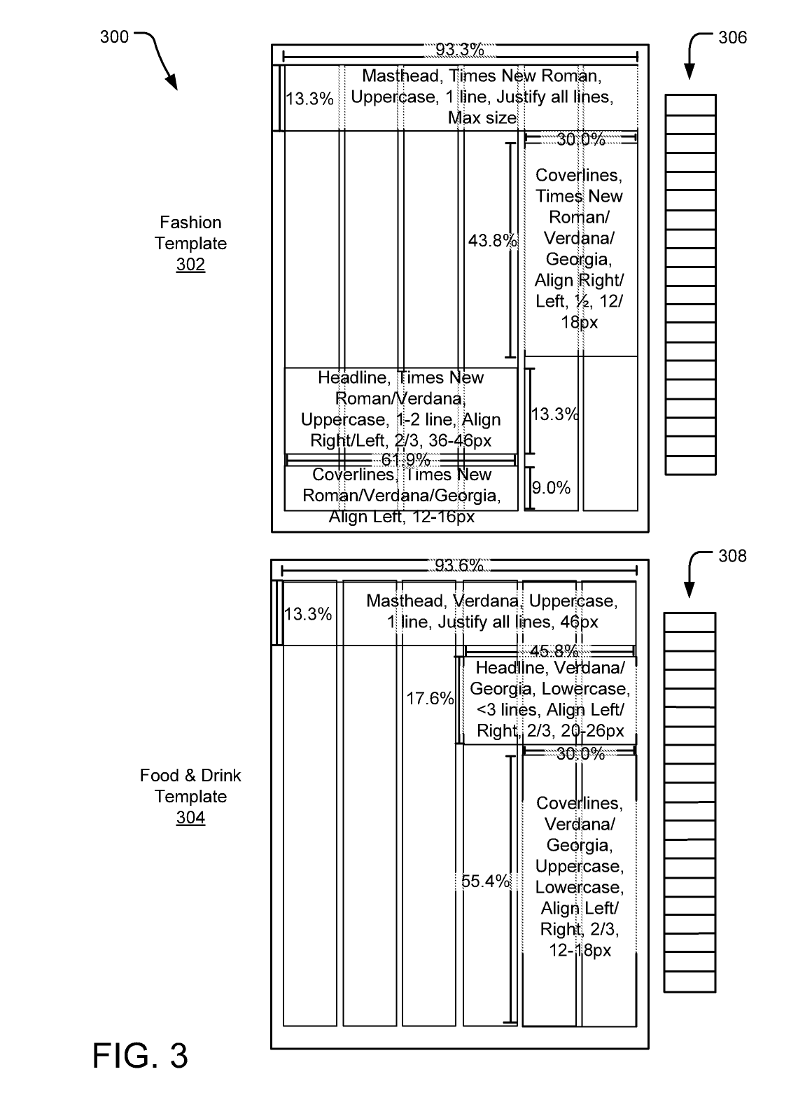

A domain-based layout guide selector 226 inputs the identified domain(s) 222 and accesses a datastore of domain-based layout guides 228 (e.g., each guide including a domain-based spatial layout template, color scheme, and or other layout constraints). Domain-based layout guides 228 include layout guides, such as templates, typographic schemes, design rules, color composition specifications, etc., associated with layouts for specified domains. For example, a domain-based layout guide 228 may include layout templates (see FIG. 3), typography schemes, color composition specifications, etc. associated with the “fashion” domain or the “food & drink” domain. Based on the identified domain(s) 222, the domain-based layout guide selector 226 selects and outputs one or more selected domain-based layout guides 230 that can be used for automated layout of the selected content 224.

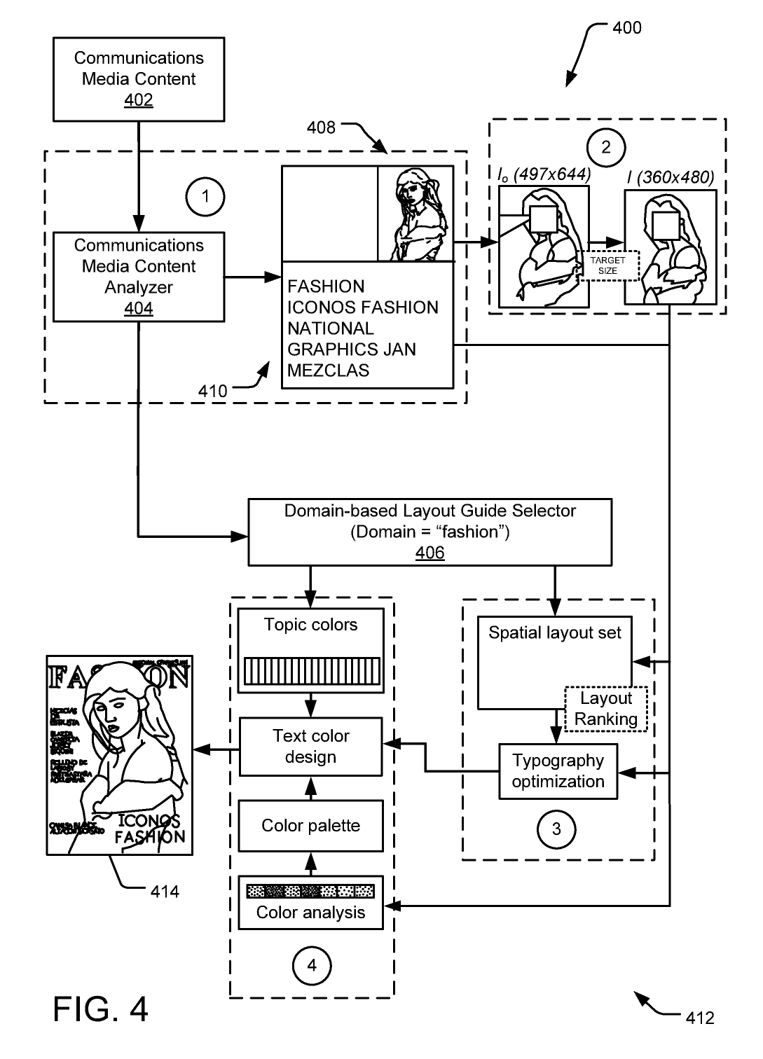

A communications media content layout generator 232 inputs the one or more selected domain-based layout guides 230 and the selected content 224, applying the one or more selected domain-based layout guides 230 to the selected content to generate a generated communications media content layout 210, as described with regard to FIGS. 4-7.

FIG. 3 illustrates example domain-based spatial layout templates 300 useful in generating domain-based layout of communications media content. Generation of visual-textual communication media layout is a complicated interaction among numerous design elements. For example, the color, font, size, and placement of a title (e.g., at the top or bottom of a page) can significantly depend on the domain (e.g., topic) of the communications media (e.g., magazine, newsletter, web page, etc.). As a more specific example, an expert media designer in the food & drink domain would rarely use a “blue” color scheme for such content layout. Nevertheless, such design guidance is difficult, if not impossible, to implement using a rigid computational model.

Accordingly, domain-based spatial layout templates 300 are used to incorporate the design insights of domain experts. One type of domain-based spatial layout templates 300 includes a domain-based layout template, such as a “fashion” template 302 or a “food & drink” template 304, which features constraints of the interactions among visual and textual elements for a particular domain. In one implementation, design experts can be interviewed to generate domain-based layout templates for various domains. Such templates include a variety of general design constraints, including those related to symmetric/asymmetric visual balance in golden ratio distribution and the art of space, as well as domain-specific constraints relating to aspects of domain-based font emotion, font size constraints, semantic color, and color harmonic modeling. In an alternative implementation, an automated survey of domain-specific can be executed on a large training set to identify general design constraints, which can then be applied in a domain-specific template.

The fashion template 302 specifies four text regions:
A masthead using upper case Times New Roman font in a single line of fully justified, maximum-sized text resulting in a region layout area of 93.3% by 13.3% of the width and height of the total layout area. Placement of the masthead (e.g., reference coordinates) may also be specified.
A coverlines region using Times New Roman, Verdana, or Georgia font with half line spacing of left or right justified, 12-18 pixel-sized text resulting in a region layout area of 30.0% by 43.8% of the width and height of the total layout area. Placement of the coverlines region (e.g., reference coordinates) may also be specified.
A headline region using upper case Times New Roman or Verdana font in 1-2 lines with a half line spacing of left or right justified, 36-46 pixel-sized text resulting in a region layout area of 61.9% by 13.3% of the width and height of the total layout area. Placement of the headline region (e.g., reference coordinates) may also be specified.
Another coverlines region using upper case Times New Roman or Verdana font in 1-2 lines with a half line spacing of left justified, 12-16 pixel-sized text resulting in a region layout area of 61.9% by 9.0% of the width and height of the total layout area. Placement of the coverlines region (e.g., reference coordinates) may also be specified.

A semantic color scheme 306, which shows a spectrum of domain-appropriate colors, is also specified for the fashion template 302.

In contrast, the food & drink template 304 specifies three text regions:
A masthead using upper case Verdana font in a single line of fully justified, 46 pixel-sized text resulting in a region layout area of 93.6% by 13.3% of the width and height of the total layout area. Placement of the masthead (e.g., reference coordinates) may also be specified.
A headline region using lower case Verdana, or Georgia font in less than 3 lines with ⅔ spacing of left or right justified, 20-26 pixel-sized text resulting in a region layout area of 45.8% by 17.6% of the width and height of the total layout area. Placement of the headline region (e.g., reference coordinates) may also be specified.
A coverlines region using upper or lower case Verdana or Georgia font with ⅔ line spacing of left or right justified, 12-18 pixel-sized text resulting in a region layout area of 30.0% by 55.4% of the width and height of the total layout area. Placement of the coverlines region (e.g., reference coordinates) may also be specified.

A semantic color scheme 308, which shows a spectrum of domain-appropriate colors, is also specified for the food & drink template 304. The semantic color schemes 306 and 308 are based on different domains, and therefore, differ (or are likely to differ) from one another based on the aesthetics the different domains. Multiple domain-based templates may be specified for each domain to provide a rich selection of possible domain-based layouts for selection by the domain-based layout generator.

Some aesthetic principles are applied to construct appealing visual-textual layouts. Yet, these aesthetic principles are difficult or impossible to implement using rigid computational mechanisms. As such, the domain-based templates 300 incorporate aesthetic principles provided by human input and thereby influence the domain-based layout of the communication media content. Example aesthetic principles may include without limitation spatial layout and domain-dependent style.

Spatial layout influences how elements in a layout affect the perceptions of other elements in the layout. Accordingly, the entire visual-textual layout is considered as a whole, rather than as a sum of individual visual and textual elements. Many principles of special relationships, contrast and similarity, and proportion are applied in the designing of a spatial layout aspect of a domain-based layout template. The visual weight of each element is considered to maintain symmetrical balance and the golden ratio (i.e., among the positions of salient objects in an image).

In one implementation, 16 types of spatial layout templates were defined for a magazine cover, although additional spatial layout templates may be defined. The spatial layout templates were ranked by domain constraints and the degree of intrusion when the spatial layouts were overlaid on a background image. Using this ranking, in part, one or more of the most effective domain-based layout templates may be assigned to a given domain.

Domain-dependent style associates each domain with a specific set of stylistic constraints, including without limitation font emotion, font size constraints, semantic colors, and harmonic color models. A database for aesthetic visual analysis defines a large-scale relationship between an aesthetic score and a selected dominant image. Different kinds of images correspond to different aesthetic styles. For example, an image in the fashion domain is colorful with wide distribution on a hue wheel and encourages the use of bright colors elsewhere in the fashion domain layout. For each domain, the preferred emotion, colors, and even harmonic model may differ significantly. As such, for each domain, existing training data from hundreds of existing rich media posts from popular social media sites have been collected, and layout design experts have summarized the dominant design principles from this training data for each domain. In one implementation, these dominant design principles include font emotion, font size constraints, semantic colors, and harmonic color models, although other principles may be defined and applied.

Font emotion is associated with a font family, which determines the external shape of a textual character. The external shape of the textual character acts as a visual element that stimulates certain human perception. For example, serif fonts, such as Times new Roman, with brisk corners bring a happy and elegant feeling while sans-serif fonts, such as Segoe, make people feel peaceable and sober. One or more suitable fonts are assigned to each domain and/or each different layout region (e.g., masthead, headline, coverlines, subtitle, etc.), based on the intended emotional response for that domain.

Font size assists in guiding the movement of a readers' focus. People are used to perceiving information according to descending text sizes. According to focus flow, different layout regions are defined. For example, in FIG. 3, masthead, headline, and coverline layout regions are depicted, each having a range of reasonable font sizes with consistency of font sizes within each layout region. In one implementation, the masthead is defined with a larger font size as compared to the headlines and the coverlines to direct the reader's focus flow from the masthead to the headlines to the coverlines.

Humans are very sensitive to color, and color reflects semantic information. Accordingly, semantic colors are used to communicate the semantic information to the reader. For example, a human's eyes are more sensitive to red as compared with other colors in the visible spectrum (e.g., red is usually used to convey warning or danger). In some layouts and/or domains, a three-color combination is used to present a certain adjective feelings like “dynamic and active” or “warm.” In other layouts and/or domains, other color schemes (e.g., single color or five-color schemes) may be used.

Semantic color schemes are grouped in association with individual domains. One or more semantic color schemes are associated with individual domains based on layout design experts according to harmonic and semantic connotations. For example, layout design experts have associated high saturation blue with the travel, health, and fashion domains, whereas such blue is discouraged in association with the food & drink domain, based on the perceived reactions of readers when reading food and drink content. As such, for each domain, existing training data from hundreds of existing rich media posts from popular social media sites have been collected, and layout design experts have identified appropriate semantic color schemes from this training data for each domain.

A color harmonic model defines hue distributions and tone distributions. Such color models are used to overlay the text with harmonic color in the layouts, by shifting an initial text color to a more appropriate harmonic color template. An initial text color may be selected as dependent on local and global image color features and then changed according to the color harmonic model based on the identified domain of the layout. Example color harmonic models may include without limitation the “V” and the “Y” models.

In an example of a travel domain, travel media typically includes a natural scene with a wide view and a large portion of natural color. When defining a harmonic text color in association with a travel domain, a text color that compliments the natural color in the dominant background image is expected by the reader. In contrast, fashion domain media typically includes a background image containing one or more people. Accordingly, the definition of harmonic text color is analogous to the salient dominant color of the populated background image (e.g., flesh tones, fabric tones, etc.).

In summary, domain-based spatial layout templates are combined with domain-based stylistic principles (e.g., font emotion, font size constraints, semantic colors, and harmonic color models) in domain-based layout guides. A domain-based layout generator selects an appropriate domain-based layout guide based on an identified domain determined from selected communications media content elements. Based on the domain-based layout guide, the domain-based layout generator develops a composition the selected communications media content that is laid out as appropriate to the identified domain.

FIG. 4 illustrates a framework for an example layout generation system 400 for generating domain-based layout of communications media content 402. The communications media content 402 may include without limitation one or more of the following: one or more images, text, audio and video content, embedded files, placeholders for served graphical controls, etc. The communications media content 402 is input to a communications media content analyzer 404 to identify one or more identified domains 406 (e.g., “fashion” in this case), a dominant image 408 (or one or more dominant images), and key text 410. The identified domain is used by a domain-based layout guide selector 406 to select the domain-based layout guide 412, which is used to develop a layout for the selected communications media content that is appropriate to the identified domain (as shown as generated communications media content layout 414).

In a first stage of operation (designated by the circled number 1), the communications media content analyzer 404 identifies and outputs the dominant image 408 and the key text 410, along with the identified domain(s). The example layout generation system 400 additionally or alternatively allows a user to upload a desired visual background image with domain attribution and some key textual phrases.

In a second stage of operation (designated by the circled number 2 and referred to as “image composition”), one or more images are processed to obtain the visual importance map by combing saliency, face, text, and gaze attention maps. Each image is shifted, cropped, and/or resized, if necessary, to match the target layout size and to preserve the important regions (e.g., eyes), according to the visual importance map. The modified image is then used to rank the layout templates in terms of spatial distribution.

In a third stage of operation (designated by the circled number 3 and referred to as “typographic overlaying”), given the modified image, the key text, and the spatial layout, the text is overlaid on the background image by an energy optimization process. In a fourth stage of operation (designated by the circled number 4 and referred to as “harmonic color design”), the example layout generation system 400 colors the text according to the domain-based constraints. The color palette is first analyzed from the modified image, while the domain colors are selected through domain attribution. By applying a selected hue/tone model, color palette, semantic color scheme, and content features, the text is recolored by maintaining the global color harmonization and local readability (e.g., avoiding regions in which text is unreadable over a background image region of the same color). Global color harmonization evaluates the colors of all elements (pixels of background image, foreground objects, and overlaid text) globally (e.g., through the entire image), searching for colors belonging to one of the utilized color harmonic models. By using the colors in one of these models, the text may be colored to maintain color harmonization within the image.

In addition to the domain-based layout guides, content-based image features, such as a saliency map, may also be considered in the automated generation of a communications media layout. For example, analyzing the features of the dominant image, the image can be sized, placed, cropped, etc. so as to prevent occlusion of salient image features (e.g., a subject's eyes) by the textual content.

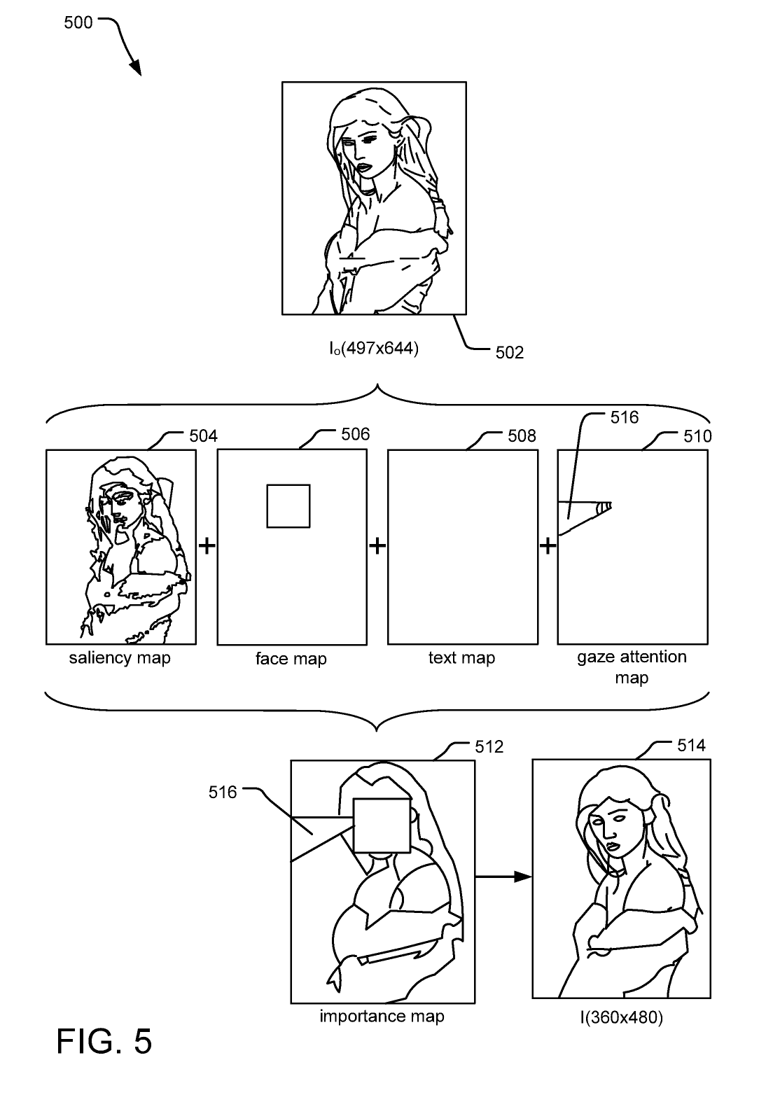

FIG. 5 illustrates an example process 500 for domain-based alignment of an input image to a target layout, representing an example image composition process. Although the described technology highlights shifting, cropping, and/or resizing to accommodate placement, occlusion, and resolution mismatch issues, other image retargeting techniques may be employed, including without limitation resampling the image. The example image composition process 500 crops and scales the original image to a target resolution, subject to identified important regions which may include important information, such as faces, eyes, text, salient objects, human attention, etc.

Given an initial image 502 (Iₒ) (e.g., having a resolution of 497×644), the example image composition process 500 applies saliency detection (at saliency map 504), face detection (at face map 506), optical character recognition (at text map 508) and gaze detection (at gaze attention map 510). The example image composition process 500 applies a maximization operation on all of the maps 504, 506, 508, and 510 to produce a combined importance map 512, which is used to generate a resulting modified image 514 (I) (e.g., having a resolution of 360×480).

For example, to compose an image I with a resolution [w, h] from an initial image Iₒ with a resolution of [wₒ, hₒ], the example image composition process 500 can maximize the importance value under the cropping mask with the same aspect ratio to image I. The cropped image is then scaled to the resolution [w, h]. By detecting the positions of eyes in the image and the direction of the human's head in the image, the gaze attention map 510 can be computed to determine the human's gaze direction, which signifies an important region 516 of the image.

In one implementation, the importance map is the combination of four maps (saliency, face, text and gaze maps), although more or fewer maps may be employed in other implementations. Once the importance map is obtained, it may be binarized (i.e., 0/1 value for each pixel on the importance map) and then the largest single rectangle is defined to cover the largest number of “important” pixels on the binarized importance map. In this manner, as many of the salient or important pixels in the modified image as possible are bounded within this rectangle, which forms the cropping boundary for the modified image

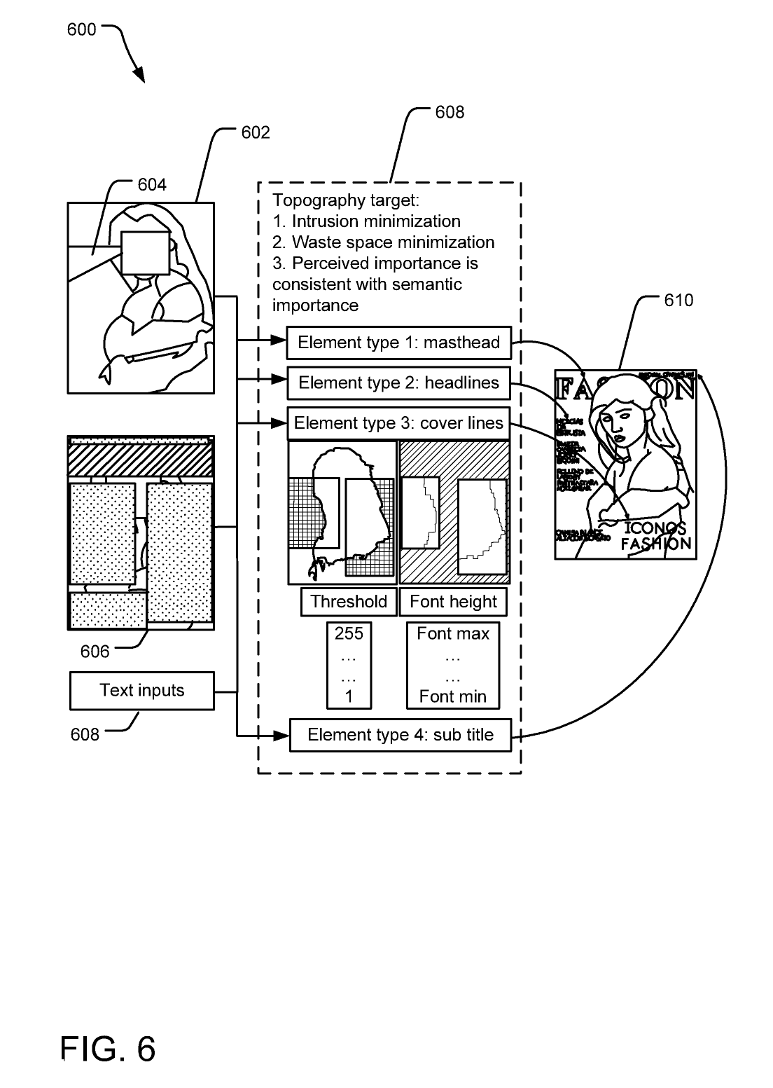

FIG. 6 illustrates an example domain-based typography composition process 600 for a domain-based layout L of communications media content. The typography composition process 600 overlays text onto the background image(s). In one implementation, the typography composition process 600 is implemented as an energy optimization problem that minimizes the cost of text intrusion, the waste of spare visual space, and the mis-match of information importance in perception and semantics, with domain-based constraints in the automatically selected template.

The input of the typography composition process 600 includes text inputs 608 (e.g., the text sentences S={S₁, . . . , S_{N}}), the processed image I from image composition, the identified domain, and a domain-based template selected from the top ranked domain-based templates. The details of the typography process 600 are illustrated within the box 609 to yield the generated communications media content layout 610 containing bottom-up image features and top-down spatial layout constraints.

The variable uᵢ denotes the weight of semantic importance of the sentence S₁. Since the order of sentences indicates the order of importance, a descending array U={u₁, . . . , u_{N}}, uᵢ=i/N is constructed so that each sentence Sᵢ is assigned with an importance weight uᵢ. Priority of sentences decrease along with the index, as shown by the descending weights u₁≧u₂≧ . . . ≧u_{N}.

The variables h and w denote the height and width of resized image I. According to the gaze attention map Iₐ, and the image importance map Iₘ (shown as visual importance map 602 with gaze attention 604 in FIG. 6), which represents the maximizing operation on the saliency, face, and text maps, the sentences are usually cut into several segments to avoid intrusion into salient objects in the image. Instead of simply dividing the layout into a grid, with one character allocated for one grid cell, an implementation of the described technology accounts for the different shapes of different font families and different combination of characters. A text block is defined in an image as Lᵢ=(pᵢ,hᵢ,(xᵢ,yᵢ)). The variable pᵢε(D,U,F)ᵢ indicates the outer shape of the text block, where D consists of all possible phrasing variations in sentence Sᵢ, U={left, center, right,} represents the alignment variations of text in the text block, and F={all_font_families} contains the aspect ratios of each character. The variable hi represents the height of the character in the sentence, which will be used to scale the shape of the text block. The coordinate (xᵢ, yᵢ) represents the pixel-wise, two-dimensional shift of the text block's left-top point relative to the left-tope point of the image. The text region R(L) is defined so that each pixel covered by the text block belongs to R(L) (i.e., (x,y)εR(L)).

The energy cost is measured according to the following equation:

E(L)=Eₛ(L)+μᵤEᵤ(L)+μₘEₘ(L),

where Eₛ is the cost metric of text intrusion into salient visual objects on image I, Eᵤ indicates the waste metric of spare visual space in the image I, and Eₘ represents the mismatch metric between semantic importance uᵢ and the visual perceived importance wᵢ of the text blocks.

$${E}_{s} ( L ) = {\sum }_{i = 1}^{n} {a}_{i} {J}_{i}$$

$$where$$

$${J}_{i} = \frac{{\sum }_{( x , y ) ∈ R ( {L}_{i} )} {i}_{m} ( x , y )}{{\sum }_{( x , y ) ∈ R ( {L}_{i} )} 255}$$

and aᵢεA indicates the weight for each element in a certain template T, A={0.1, 0.1, 0.7, 0.1} corresponding to the weight of “Masthead,” “Headline,” “CoverLines,” and “Subtitle.” The variable Eᵤ is defined as the waste of spare visual space, meaning that, after binarizing the importance map Iₘ with threshold

$$t = {max}_{( x , y ) ∈ R ( L )} {I}_{m} ( x , y ) ,$$

the full use of regions under threshold is encouraged.

In mismatch energy

$${E}_{m} = \sum {a}_{i} \frac{\vert {w}_{i} - {ku}_{i} \vert}{hw} , \\ {w}_{i} = {\sum }_{( x , y ) ∈ R ( L )} {I}_{a} ( x , y ) .$$

The energy aligns important textual sentences to attractive regions with gaze attention.

Given a set of domain-specific templates, an effective method for ranking the templates for various communications media content may be applied. Each spatial template is scored according to:

$${S}_{c} ( L ) = 100 ( 1 - {\sum }_{j = 1}^{4} {a}_{j} {Q}_{,} ) , \\ where$$

$${Q}_{j} = \frac{{\sum }_{( x , y ) ∈ R ( L )} {I}_{m} ( x , y )}{{\sum }_{( x , y ) ∈ R ( {L}_{j} )} 255} .$$

The variable Tⱼ notes the element type j in the layout template, and R(Tⱼ) indicates the mask regions in j type element (e.g., “Masthead,” “Headline,” “CoverLines,” “Subtitle”) (see region map 606 with 4 elements). A predefined number of templates with the highest score are filtered into the following energy minimization process.

To address the complexity of the typography process 600, each element is processed individually, although other more parallel or integrated approaches may be used. The threshold t is adaptive to a sub-optimized problem with search paths defined by the threshold

$$t = {max}_{( x , y ) ∈ R ( L )} {I}_{m} ( x , y ) ,$$

with the threshold t is increased between 1 and 256. The smaller the resulting threshold t, the less error and intrusion introduced to the generated communications media content layout 610. When the threshold is determined, text can be placed in non-salient regions. By minimizing the waste of empty space, the font size is selected within a given range. The maximum font size need not only be determined by it's the fonts own constraints but may also be influenced other types of template elements with associated font size constraints.

The color design for textual and graphical elements is challenging because of the high sensitivity humans have to color. A harmonic color scheme can generate highly attractive visual layouts for humans and offer improved experience for long period of reading. Typically, harmonic color design includes without limitation (1) keeping the text color in global harmonization with the background image, and (2) preserving the local readability of the text. Harmonic color design is accomplished at least in part by summarized semantic colors summarized by domain-knowledgeable designers and various harmonic models.

As shown in FIG. 4, a color palette is extracted from a modified image Iₘ. The extracted color palette may be limited to a predetermined number of colors or adapted based on the domain and/or the background image. In one implementation, the color palette consists of seven colors, in which the first four are taken from salient objects in the image and the other three are from non-salient objects in the image. In addition, the semantic colors are identified by the image domain and are used to supervise the generation of text color. According to the definition of the dominant color in the template, the dominant color is selected from the color palette. The semantic colors are iterated to calculate the matching scores with the dominant color in a certain hue harmonic template. The color with maximum response is extracted as a basis color for text in the layout. In one implementation, the type “i” hue harmonic template is applied to control the hue of other text. After identifying the hue of each text element, certain tone models may also be applied to provide visual contrast against the overlaid regions of the background image.

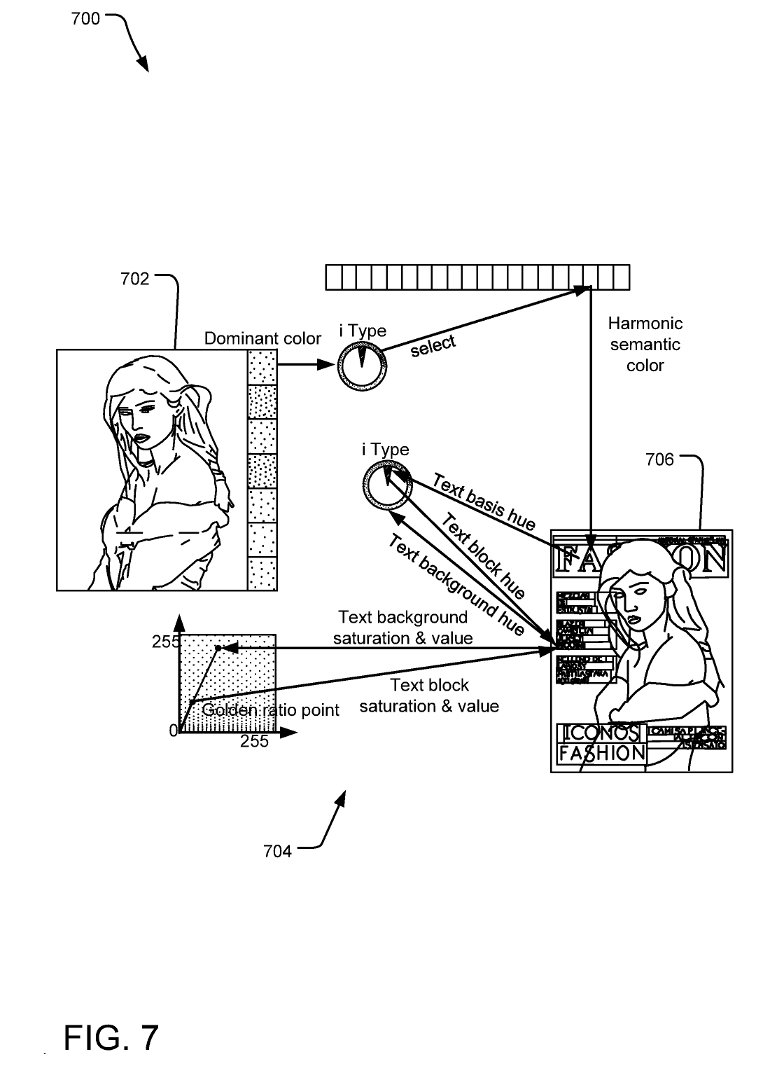

FIG. 7 illustrates an example domain-based color composition process 700 for a domain-based layout of communications media content. For different domains, there may be different semantic colors, different rules for selecting dominant color, and different color harmonic models, as previously discussed. The domain of the image 702 in FIG. 7 is “fashion.” In the fashion domain, the dominant color is defined as the most frequent color in the salient region of the image 702. According to this protocol, the first color in the color palette is selected as the dominant color, which reflects the basis color in visual parts. By applying the analogous hue type in the domain, the basis color for textual elements is assigned to a semantic color that has the maximum matching score with the domain color in the analogous hue type. The harmonic color is then selected as the color closest to the dominant color on a hue wheel.

In a magazine cover style layout, the masthead with the most salient location and maximum allowable font size is used to determine the basis color of textual elements. The masthead is set to the harmonic semantic color, and the text in other elements are identified through the domain-dependent harmonic model and the local image features. First, the hue value of the text is set in “i” type template. Then, to compensate the contrast with the text's local background in the image 702, an extended tone template is applied to prevent the text from washing out in the local background of the image 702. The tone of the text is set at the golden ratio point between the local background tone and the farthest possible opposite direction in the saturation and value coordinates in a graph 704. The selected text colors are applied to generate communications media content layout 706.

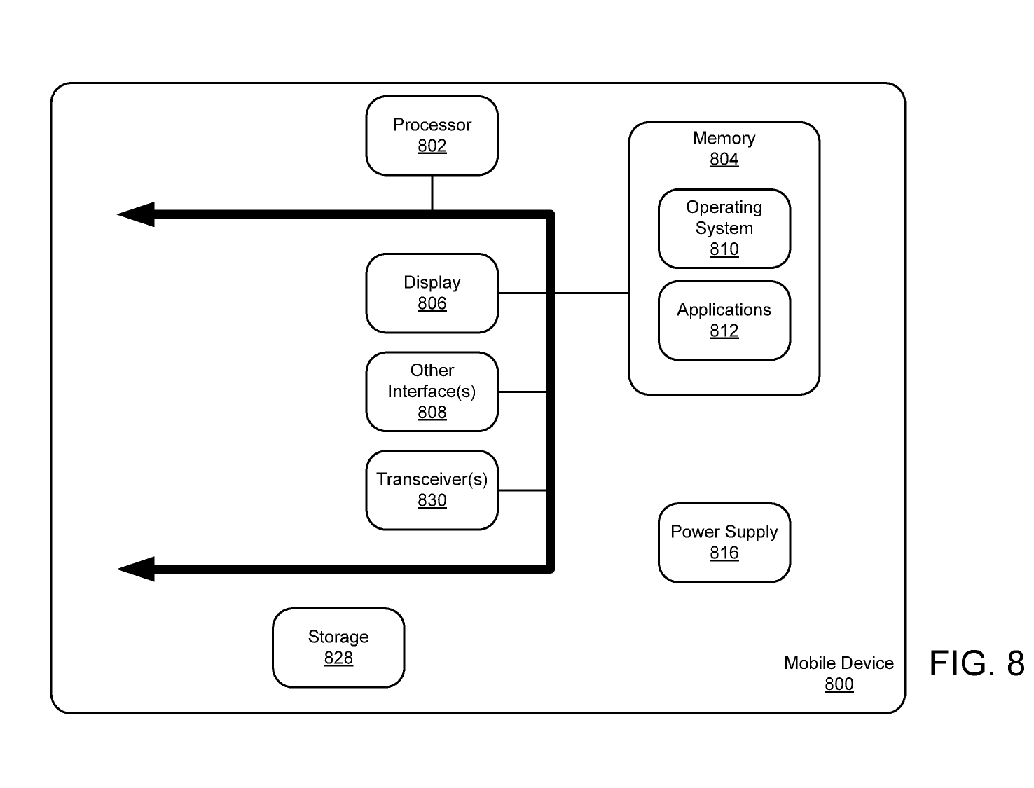

FIG. 8 illustrates an example computing system 800 that may be useful for generating a domain-based communications media content layout. A computing system, which may be stand-alone, distributed, mobile, or otherwise, includes one or more processors 802, memory 804, a display 806 (e.g., a touchscreen display), and other interfaces 808 (e.g., a keyboard). The memory 804 generally includes both volatile memory (e.g., RAM) and non-volatile memory (e.g., flash memory). An operating system 810, such as the Microsoft Windows® operating system, resides in the memory 804 and is executed by the processor 802, although it should be understood that other operating systems may be employed.

One or more application programs 812 are loaded in the memory 804 and executed on the operating system 810 by the processor 802. Examples of applications 812 include without limitation a domain-based layout generator. The computing system 800 includes a power supply 816, which is powered by one or more batteries or other power sources and which provides power to other components of the computing system 800. The power supply 816 may also be connected to an external power source that overrides or recharges the built-in batteries or other power sources. The computing system 800 includes one or more communication transceivers 830 to provide network connectivity (e.g., mobile phone network, Wi-Fi®, BlueTooth®, etc.). Other configurations may also be employed.

In an example implementation, a communications media content analyzer, a domain-based layout guide selector, a communications media content layout generator, and other computing modules may be embodied by instructions stored in memory 804 and/or storage devices 828 and processed by the processor 802. Domain-based layout guides, layout templates, color templates, color palettes, maps, images, text, rankings, fonts, domain identifiers, and other data may be stored in memory 804 and/or storage devices 828 as persistent datastores.

The computing system 800 may include a variety of tangible computer-readable storage media and intangible computer-readable communication signals. Tangible computer-readable storage can be embodied by any available physical media that can be accessed by the computing system 800 and includes both volatile and nonvolatile storage media and removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can accessed by the computing system 800. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal.

In one example system for generating a composition of communications media content based on an identified domain, a communications media content analyzer executes on one or more processors and identifies the identified domain associated with the communications media content. A domain-based layout guide selector executes on the one or more processors, receives the identified domain from the communications media content analyzer, and selects a domain-based layout guide based on the identified domain. The domain-based layout guide is selected from a set of domain-based layout guides stored in memory accessible by the one or more processors. The set of domain-based layout guides being associated with multiple domains. A communications media content layout generator executes on the one or more processors, receives the selected domain-based layout guide from the domain-based layout guide selector, and generates the composition of communications media content according to a communications media content layout incorporating at least a subset of the communications media content. The communications media content layout complies with the selected domain-based layout guide.

In another example system of any preceding system, the communications media analyzer analyzes the communications media content to identify the domain.

In another example system of any preceding system, the communications media analyzer analyzes the communications media content to key text and at least one background image.

In another example system of any preceding system, the domain-based layout guide specifies at least one of a domain-based color palette or a domain-based spatial layout set.

In another example system of any preceding system, the communications media content layout generator includes a typography composer executing on the one or more processors, the typography composer defining layout of text relative to the at least one background image according to a selected domain-based spatial layout selected by ranking against other domain-based spatial layouts in the specified domain-based spatial layout set.

In another example system of any preceding system, the communications media content layout generator analyzes the at least one background image to define a background color palette and selects domain-based colors based on the identified domain, the background color palette and the selected domain-based colors being combined with the selected domain-based spatial layout and the at least a subset of the communications media content into the generated communications media content layout.

In another example system of any preceding system, the typography composer defines the layout of text based on a metric of text intrusion into salient visual objects in the at least one background image.

In another example system of any preceding system, the typography composer defines the layout of text based on a metric of mismatch between semantic importance of blocks of the text and visual perceived importance of the blocks of the text.

In another example system of any preceding system, the typography composer defines the layout of text based on a metric of a waste of spare visual space within the layout relative to salient visual objects in the at least one background image.

In an example processor-implemented method of generating a composition of communications media content based on a domain, the method includes identifying the domain associated with the communications media content and selecting a domain-based layout guide based on the identified domain. The domain-based layout guide is selected from a set of domain-based layout guides stored in memory accessible by the one or more processors. The set of domain-based layout guides is associated with multiple domains. The method further includes generating the composition of communications media content according to a communications media content layout incorporating at least a subset of the communications media content. The communications media content layout complies with the selected domain-based layout guide.

In an example processor-implemented method of any preceding claim, the identifying operation includes analyzing the communications media content to identify the domain.

In an example processor-implemented method of any preceding claim, the identifying operation includes analyzing the communications media content to identify key text and at least one background image.

In an example processor-implemented method of any preceding claim, the domain-based layout guide specifies at least one of a domain-based color palette or a domain-based spatial layout set.

In an example processor-implemented method of any preceding claim, the generating operation includes defining layout of text relative to the at least one background image according to a selected domain-based spatial layout selected by ranking against other domain-based spatial layouts in the specified domain-based spatial layout set.

In an example processor-implemented method of any preceding claim, the generating operation further includes analyzing the at least one background image to define a background color palette and selecting domain-based colors based on the identified domain. The background color palette and the selected domain-based colors are combined with the selected domain-based spatial layout and the at least a subset of the communications media content into the generated communications media content layout.

In an example processor-implemented method of any preceding claim, the generating operation further includes defining the layout of text based on a metric of text intrusion into salient visual objects in the at least one background image.

In an example processor-implemented method of any preceding claim, the generating operation further includes defining the layout of text based on a metric of mismatch between semantic importance of blocks of the text and visual perceived importance of the blocks of the text.

In an example processor-implemented method of any preceding claim, the generating operation further includes defining the layout of text based on a metric of a waste of spare visual space within the layout relative to salient visual objects in the at least one background image.

In one or more tangible computer-readable storage media encoding computer-executable instructions for executing on a computer system an example computer process for generating a composition of communications media content based on a domain, the computer process including identifying the domain associated with the communications media content and selecting a domain-based layout guide based on the identified domain. The domain-based layout guide is selected from a set of domain-based layout guides stored in memory accessible by the one or more processors. The set of domain-based layout guides is associated with multiple domains. The example computer process further includes generating the composition of communications media content according to a communications media content layout incorporating at least a subset of the communications media content. The communications media content layout complies with the selected domain-based layout guide.

The one or more tangible computer-readable storage media of any preceding claim wherein the generating operation further includes defining the layout of text based on at least one of a metric of text intrusion into salient visual objects in the at least one background image, a metric of mismatch between semantic importance of blocks of the text and visual perceived importance of the blocks of the text, or a metric of a waste of spare visual space within the layout relative to salient visual objects in the at least one background image.

In an example system for generating a composition of communications media content based on a domain, the system includes means for identifying the domain associated with the communications media content and means for selecting a domain-based layout guide based on the identified domain. The domain-based layout guide is selected from a set of domain-based layout guides stored in memory accessible by the one or more processors. The set of domain-based layout guides is associated with multiple domains. The system further includes means for generating the composition of communications media content according to a communications media content layout incorporating at least a subset of the communications media content. The communications media content layout complies with the selected domain-based layout guide.

In an example system of any preceding claim, the means for identifying includes means for analyzing the communications media content to identify the domain.

In an example system of any preceding claim, the means for identifying includes means for analyzing the communications media content to identify key text and at least one background image.

In an example system of any preceding claim, the domain-based layout guide specifies at least one of a domain-based color palette or a domain-based spatial layout set.

In an example system of any preceding claim, the means for generating includes means for defining layout of text relative to the at least one background image according to a selected domain-based spatial layout selected by ranking against other domain-based spatial layouts in the specified domain-based spatial layout set.

In an example system of any preceding claim, the means for generating further includes means for analyzing the at least one background image to define a background color palette and means for selecting domain-based colors based on the identified domain. The background color palette and the selected domain-based colors are combined with the selected domain-based spatial layout and the at least a subset of the communications media content into the generated communications media content layout.

In an example system of any preceding claim, the means for generating further includes means for defining the layout of text based on a metric of text intrusion into salient visual objects in the at least one background image.

In an example system of any preceding claim, the means for generating further includes means for defining the layout of text based on a metric of mismatch between semantic importance of blocks of the text and visual perceived importance of the blocks of the text.

In an example system of any preceding claim, the means for generating further includes means for defining the layout of text based on a metric of a waste of spare visual space within the layout relative to salient visual objects in the at least one background image.

In another example system for generating a composition of communications media content based on a domain, the system includes one or more computing processors, memory, and a communications media content analyzer executing on the one or more processors. The communications media content analyzer identifies the domain associated with the communications media content. A domain-based layout guide selector executes on the one or more processors and selects a domain-based layout guide based on the identified domain. The domain-based layout guide is selected from a set of domain-based layout guides stored in memory accessible by the one or more processors. The set of domain-based layout guides is associated with multiple domains. A communications media content layout generator executes on the one or more processors and generates the composition of communications media content according to a communications media content layout incorporating at least a subset of the communications media content. The communications media content layout complies with the selected domain-based layout guide. The generated composition of communications media content is stored in the memory.

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A system for generating a composition of communications media content based on an identified domain comprising:
a communications media content analyzer executing on one or more processors, the communications media content analyzer identifying the identified domain associated with the communications media content;
a domain-based layout guide selector executing on the one or more processors, the domain-based layout guide selector receiving the identified domain from the communications media content analyzer and selecting a domain-based layout guide based on the identified domain, the domain-based layout guide being selected from a set of domain-based layout guides stored in memory accessible by the one or more processors, the set of domain-based layout guides being associated with multiple domains; and
a communications media content layout generator executing on the one or more processors, the communications media content layout generator receiving the selected domain-based layout guide from the domain-based layout guide selector and generating the composition of communications media content according to a communications media content layout incorporating at least a subset of the communications media content, the communications media content layout complying with the selected domain-based layout guide.

2. The system of claim 1 wherein the communications media analyzer analyzes the communications media content to identify the domain.

3. The system of claim 1 wherein the communications media analyzer analyzes the communications media content to key text and at least one background image.

4. The system of claim 3 wherein the domain-based layout guide specifies at least one of a domain-based color palette or a domain-based spatial layout set.

5. The system of claim 4 wherein the communications media content layout generator includes a typography composer executing on the one or more processors, the typography composer defining layout of text relative to the at least one background image according to a selected domain-based spatial layout selected by ranking against other domain-based spatial layouts in the specified domain-based spatial layout set.

6. The system of claim 5 wherein the communications media content layout generator analyzes the at least one background image to define a background color palette and selects domain-based colors based on the identified domain, the background color palette and the selected domain-based colors being combined with the selected domain-based spatial layout and the at least a subset of the communications media content into the generated communications media content layout.

7. The system of claim 5 wherein the typography composer defines the layout of text based on a metric of text intrusion into salient visual objects in the at least one background image.

8. The system of claim 5 wherein the typography composer defines the layout of text based on a metric of mismatch between semantic importance of blocks of the text and visual perceived importance of the blocks of the text.

9. The system of claim 5 wherein the typography composer defines the layout of text based on a metric of a waste of spare visual space within the layout relative to salient visual objects in the at least one background image.

10. A processor-implemented method of generating a composition of communications media content based on a domain, the method comprising:
identifying the domain associated with the communications media content;
selecting a domain-based layout guide based on the identified domain, the domain-based layout guide being selected from a set of domain-based layout guides stored in memory accessible by the one or more processors, the set of domain-based layout guides being associated with multiple domains; and
generating the composition of communications media content according to a communications media content layout incorporating at least a subset of the communications media content, the communications media content layout complying with the selected domain-based layout guide.

11. The processor-implemented method of claim 10 wherein the identifying operation comprises:
analyzing the communications media content to identify the domain.

12. The processor-implemented method of claim 10 wherein the identifying operation comprises:
analyzing the communications media content to identify key text and at least one background image.

13. The processor-implemented method of claim 12 wherein the domain-based layout guide specifies at least one of a domain-based color palette or a domain-based spatial layout set.

14. The processor-implemented method of claim 13 wherein the generating operation comprises:
defining layout of text relative to the at least one background image according to a selected domain-based spatial layout selected by ranking against other domain-based spatial layouts in the specified domain-based spatial layout set.

15. The processor-implemented method of claim 14 wherein the generating operation further comprises:
analyzing the at least one background image to define a background color palette and selects domain-based colors based on the identified domain, the background color palette and the selected domain-based colors being combined with the selected domain-based spatial layout and the at least a subset of the communications media content into the generated communications media content layout.

16. The processor-implemented method of claim 14 wherein the generating operation further comprises:
defining the layout of text based on a metric of text intrusion into salient visual objects in the at least one background image.

17. The processor-implemented method of claim 14 wherein the generating operation further comprises:
defining the layout of text based on a metric of mismatch between semantic importance of blocks of the text and visual perceived importance of the blocks of the text.

18. The processor-implemented method of claim 14 wherein the generating operation further comprises:
defining the layout of text based on a metric of a waste of spare visual space within the layout relative to salient visual objects in the at least one background image.

19. A system for generating a composition of communications media content based on a domain, the system comprising:
one or more computing processors;
memory;
a communications media content analyzer executing on the one or more processors, the communications media content analyzer identifying the domain associated with the communications media content;
a domain-based layout guide selector executing on the one or more processors, the domain-based layout guide selector selecting a domain-based layout guide based on the identified domain, the domain-based layout guide being selected from a set of domain-based layout guides stored in memory accessible by the one or more processors, the set of domain-based layout guides being associated with multiple domains; and
a communications media content layout generator executing on the one or more processors, the communications media content layout generator generating the composition of communications media content according to a communications media content layout incorporating at least a subset of the communications media content, the communications media content layout complying with the selected domain-based layout guide, the generated composition of communications media content being stored in the memory.

20. The system of claim 19 wherein the communications media content layout generator includes a typography composer executing on the one or more processors, the typography composer defining the layout of text based on at least one of a metric of text intrusion into salient visual objects in the at least one background image, a metric of mismatch between semantic importance of blocks of the text and visual perceived importance of the blocks of the text, or a metric of a waste of spare visual space within the layout relative to salient visual objects in the at least one background image.
